(19) United States
(12) Patent Application Publication
(10) Pub. No.: US 2012/0216830 A1
(43) Pub. Date: Aug. 30, 2012

(54) WINDSHIELD WASHER DEVICE AND METHOD FOR OPERATING SUCH A WINDSHIELD WIPER DEVICE

(75) Inventor: Joachim Zimmer, Changsha (CN)

(73) Assignee: ROBERT BOSCH GMBH, Stuttgart (DE)

(21) Appl. No.: 13/393,841

(22) PCT Filed: Jul. 13, 2010
(86) PCT No.: PCT/EP10/60010

§ 371 Date: May 15, 2012

(30) Foreign Application Priority Data
Sep. 2, 2009 (DE) 10 2009 029 098.2

(51) Int. Cl. B60S 1/06; B60S 1/28

(52) U.S. Cl. 134/6; 15/250.13

(57) ABSTRACT

The invention relates to a windshield wiper device (1) having a wiper motor (11) that can be actuated by means of a control unit (12) and that actuates a wiper (101, 102) in order to wipe a predetermined wiping area. The control unit (12) adjusts the wiping area of the wiper (101, 102) depending on an environmental and/or wiper parameter (13, 14). The invention further relates to a method for operating such a windshield wiper device (1).

### BACKGROUND OF THE INVENTION

The invention relates to a windshield wiper device having a wiper motor that can be actuated by means of a control unit and that actuates a wiper in order to wipe a predetermined wiping area. The invention further relates to a method for operating such a windshield wiper device.

Windshield wiper devices for cleaning motor vehicle window panes normally comprise a wiper motor, which moves a wiper relative to the motor vehicle window pane in the event of rain or humidity. The wiper motor is generally embodied as a dual lever synchronous wiper system having a separate wiper for the driver's and passenger's side. The wiper motor determines the wiping area via the wiping arc of the wiper as well as the reversal point of said wiper. The layout of the size of the wiping area is subject to statutory regulations. These determine the essential boundary conditions particularly for the wiping area on the driver's side. The wiping area on the driver's side is generally kept constant by means of the wiper motor in order to provide a distance to the A-pillar that is as small as possible and a large wiping area as well as to meet the statutory field of vision requirements.

In contrast, only the wiping arc on the passenger's side is predefined. A relatively large margin of play exists when adjusting the upper reversal point because there are no statutory requirements for the field of vision. There are therefore two directions of design for the passenger's side, wherein one of the two designs is used for half of all customers. According to a first design, a large wiping angle is predefined. In the case of a large wiping angle, the wiping arc of the passenger's side wipes into the wiping area of the driver's side. This can be disturbing to the driver, particularly in the case of a large volume of water if water is additionally slung into the driver's field of vision. According to a second design, a small wiping angle is predefined. In the case of a small wiping angle, the reversal point of the passenger's side wiper takes place at an early stage. In so doing, the water deposited by the passenger's side wiper at the reversal point cannot be removed by the driver's side wiper so that water runs down into the field of vision of the driver after the wiper motor has been turned off

### SUMMARY OF THE INVENTION

It is the aim of the invention to find an optimal solution for a windshield wiper device.

According to the invention, a windshield wiper device having a wiper motor is disclosed, which can be actuated by means of a control unit and that actuates a wiper in order to wipe a predetermined wiping area. The control unit thereby adjusts the wiping area of the wiper depending on an environmental and/or wiper parameter.

An advantage of the windshield wiper device according to the invention is that an adaptive wiping area can be adjusted by taking into account the environmental and/or wiper parameters when determining the wiping area as a function of the situation. Furthermore, the proportion of time, in which the driver's vision of the roadway is unimpeded, is increased by the wiping operation. This is particularly achieved as a result of the water being optimally removed according to the invention with the aid of the wiper control system.

In a further embodiment of the invention, the windshield wiper device is embodied as a dual motor windshield wiper device, wherein the two wiper motors can be separately actuated in order to individually adjust the wiping field of the associated wiper. The wiping field on the driver's side and the passenger's side can thus be separately adjusted in order to provide the driver with an unimpeded view of the roadway.

According to a further embodiment of the invention, the wiping angle of a first wiping angle setting is smaller than the wiping angle of a second wiping angle setting by at least 3 degrees. A first wiping angle setting preferably comprises a wiping angle of 90 degrees and a second wiping angle setting a wiping angle of over 90 degrees. The use of the two wiping angle settings allows for an optimal adaptation of the wiper operation to the amount of water striking the window pane.

In addition, the second wiping angle setting is implemented according to a further embodiment of the invention when the wiper is turned off. The use of said second wiping angle setting upon deactivation of the wiper is provided as an additional application. It is thereby ensured that the entire volume of water is removed from the driver's side during the last wiping action.

### BRIEF DESCRIPTION OF THE DRAWINGS

The invention is explained below in detail with the aid of the exemplary embodiments while making reference to the accompanying drawings. In the drawings, the following items are shown:

FIG. 1 a schematic depiction of a windshield wiper device; and

FIG. 2 a possible operating sequence of the windshield wiper device according to the invention from activation until deactivation.

### DETAILED DESCRIPTION

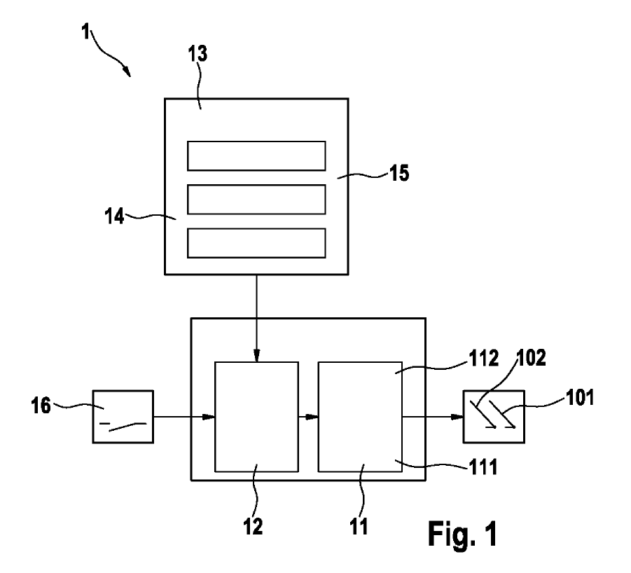

A windshield wiper device 1 is shown in a schematic depiction in FIG. 1. The windshield wiper device 1 serves in cleaning motor vehicle window panes and comprises a wiper motor system 11, which moves two wipers 101, 102 preferably synchronously relative to the motor vehicle window pane in the event of rain or humidity. The wiper motor system 11 is preferably embodied as a dual motor system, wherein the two wiper motors 111, 112 can be separately actuated. Said two wiper motors 111, 112 operate the associated wipers 101, 102 with a compact linkage or as a wiper direct drive. The wiper operation on the driver's side and the passenger's side can be decoupled from each other by means of said separate wiper motors 111, 112 in order to individually adjust the wiping area of the associated wiper 101, 102. As an alternative, said wiper motors 111, 112 can also work in opposite directions.

The driver's side wiper motor 111 maintains a consistent wiping arc as well as reversal point thereof in relation to the A-pillar on the driver's side. The wiping arc of the passenger's side wiper 102 is kept consistent by the passenger's side wiper motor 112. The determination of the upper reversal point of said passenger's side wiper 102 allows for a relatively large margin of play because statutory field of vision requirements substantially do not exist for the wiping area on the passenger's side. The wiping field on the passenger's side can thus be optimized according to the invention during the wiper operation. In addition, the option also exists according to the invention to optimize the wiping area on the driver's side if the statutory regulations permit it.

The two wiper motors 111, 112 are actuated with the aid of a control unit 12. The control unit 12 thereby adjusts the wiping area on the passenger's side according to the invention as a function of an environmental and/or wiper parameter 13, 14. The wiper parameter 13 can comprise a wiper speed and/or operating mode and the environmental parameter 14 can comprise a volume of water and/or driving speed. Further environmental and/or wiper parameters 13, 14 can alternatively be acquired. Said control unit 12 can thereby take one, several or all of the environmental and/or wiper parameters 13, 14 into account.

The wiper parameters 13 regarding wiper speed and/or operating mode, wherein the activation/deactivation operation of the wipers 101, 102 is understood among under things by the term operating mode, can be manually activated via the steering column switch 16 and/or via a rain sensor 24 in the on-board electrical system 15. The data are subsequently processed by the control unit 12. During activation and deactivation of the wipers 101, 102, the wiper 101, 102 is brought out or brought into a parked position. The environmental parameter 14 regarding driving speed can be adjusted via the on-board electrical system 15. The environmental parameter 14 regarding volume of water is ascertained via the rain sensor 24 and/or via an energy model in the on-board electrical system 15.

With the use of the rain sensor 24 or the energy model, it can be determined if and how hard it is raining in order to activate the two wiper motors 111, 112 via the control unit 12. The rain sensor 24 carries out an optical electronic measurement using a light emitting diode (LED) as the light source and a detecting photodiode. In so doing, the physical law of reflection on the boundary of an optically thicker to an optically thinner material (index of refraction) is used. A load on the wiper motor 111, 112 can be detected using the energy model. From this data, the wiping area or the speed of the wiper 101, 102 can be determined by the control unit 12.

The advantage of the windshield wiper device 1 according to the invention is that an adaptive wiping area can be adjusted on the passenger's side by taking the environmental and/or wiper parameter 13, 14 into account when defining the wiping field as a function of the situation. In addition, the view of the roadway by the driver can be increased during wiper operation.

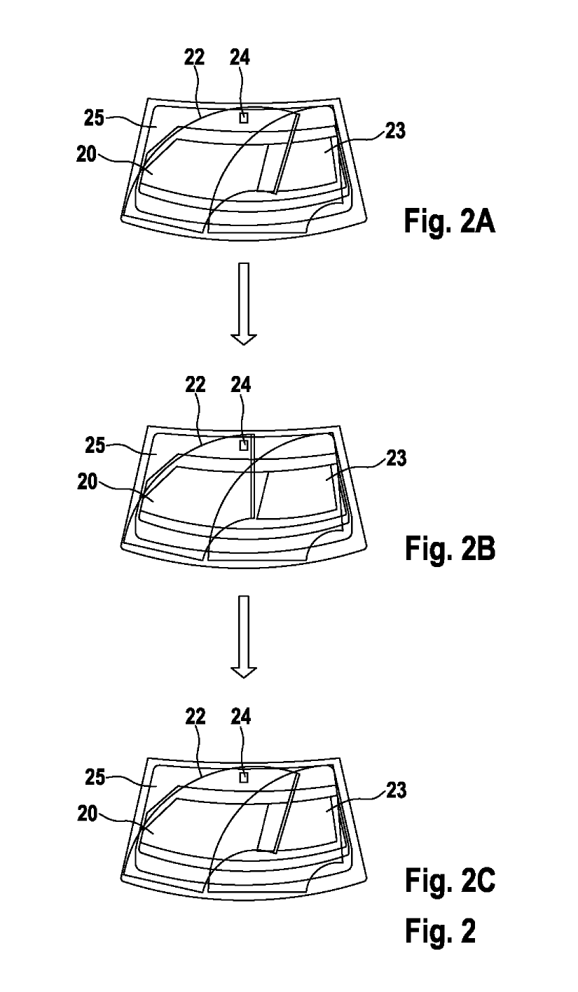

FIGS. 2A to 2C show a possible operating sequence of the windshield wiper device 1 according to the invention from activation to deactivation. The wiping field particularly on the passenger's side is thereby adjusted by the control unit 12 depending on the environmental and/or wiper parameter 13, 14, wherein a first wiping angle setting 21 comprises a wiping angle of 90 degrees and a second wiping angle setting 22 a wiping angle of over 90 degrees. The wiping angle can alternatively be configured larger or smaller. The wiping angle of the first wiping angle setting is however preferably smaller than the wiping angle of the second wiping angle setting by at least three degrees. In order to determine said first and second wiping angle setting 21, 22, the rain sensor is positioned in such a way that the volume of water striking the window pane is detected in a timely manner by the rain sensor 24. In addition, said rain sensor 24 must always be wiped by the passenger's side wiper 102.

In the first operating state, the two wipers 101, 102 are activated by switching on the steering column switch 16 or by means of the rain sensor 24 or respectively the energy model. As is shown in FIG. 2A, the passenger's side wiper 102 has the second wiping angle setting 22 comprising a wiping angle of over 90 degrees. Said second wiping angle setting 22 is primarily selected by the control unit 12 at a low wiper speed and for a small volume of water because only a small amount of water is slung into the driver's field of vision. Said second wiping angle setting 22 is thereby configured large enough for the wiping arc on the passenger's side to always cross into the wiping field on the driver's side. The water deposited by the passenger's side wiper 104 at the reversal point is however completely removed during the downward wiping action of the wiper on the driver's side 23. In so doing, no water runs into the field of vision of the driver after both wipers 101, 102 have been deactivated. This is particularly advantageous when the vehicle is at a low speed or standing because the water cannot be led away over the roof due to the lack of incident air flow. When rain dropping a large volume of water suddenly occurs, the first wiping angle setting 21 having a wiping angle of 90 degrees can alternatively be immediately selected by the control unit 12 in order that the vision of the driver is not impaired.

As is shown in FIG. 2B, the first wiping angle setting 21 comprising a wiping angle of 90 degrees is selected by the control device 12 during a second operating state, which depicts a continuous wiping mode. The first wiping angle setting 21 is primarily used at a high wiper speed, in case of a large volume of water and at a high driving speed. The reversal point of the passenger's side wiper 102 occurs early so that the passenger's side wiper 102 does not protrude into the driver's field of vision and thereby interfere with said driver's ability to handle the vehicle. In the case of large volumes of water, water is additionally slung into said driver's field of vision, whereby vision is strongly impaired. By reducing the wiping angle, the field of vision being impaired is reduced. In addition, a smaller relative wiper speed and thereby smaller dynamics are achieved; thus enabling the water volume not to be slung as far from the passenger's wiper 102 onto the field of vision of the driver. Due to the early reversal point of the passenger's side wiper 102 and the small volume of water on the driver's side 23, the driver's view of the roadway is improved during the wiper operation.

During deactivation the two wipers 101, 102, which is shown in FIG. 2C as a third operating state, the two wipers 101, 102 are brought into a parked position. In the event of the passenger's side wiper 102 being in the continuous wiping mode, the control unit then switches from the first wiping angle setting 21 over to the second wiping angle setting 22. The switching off of the two wipers 101, 102 in the parked position is carried out by actuating the steering column switch 16 or via the rain sensor 24 in the on-board electrical system. The water deposited by said passenger's side wiper 102 at the reversal point is thereby completely removed during the downward wiping action of the wiper on the driver's side 23 so that no water runs down into the field of vision of the driver after the two wipers 101, 102 have been deactivated.

In a further operating state, which is not shown in FIG. 2C, the second wiping angle setting 22 can always be selected by the control unit 12 for the passenger's side wiper 102 during an intermittent wiping operation. During the intermittent wiping operation, only a small amount of water is present on the windshield 25 so that said windshield is wiped at certain intervals. An uninterrupted view of the roadway is thereby increased for the driver during the wiper operation.

By the use of a wiper motor system 11 as a dual motor system comprising a wiper motor 111, 112 for the driver's and passenger's side, the wiping area of the passenger's side wiper 102 can be optimized. In so doing, the proportion of time in which the driver has an uninterrupted view of the roadway is increased during the wiper operation.

1. A windshield wiper device having a wiper motor (11) actuated by a control unit (12) and that actuates a wiper (101, 102) in order to wipe a predetermined wiping area, characterized in that the control unit (12) adjusts the wiping area of the wiper (101, 102) depending on one or more parameters (13, 14).

2. The windshield wiper device according to claim 1, characterized in that the one or more parameters includes a wiper parameter (13).

3. The windshield wiper device according to claim 1, characterized in that the windshield wiper device (1) is embodied as a dual motor windshield wiper device, wherein the two wiper motors (111, 112) can be separately actuated in order to individually adjust the wiping area of the associated wiper (101, 102).

4. The windshield wiper device according to claim 1, characterized in that the wiping angle of a first wiping angle setting (21) is smaller than the wiping angle of a second wiping angle setting (22).

5. The windshield wiper device according to claim 4, characterized in that the first wiping angle setting (21) comprises a wiping angle of 90 degrees and the second wiping angle setting (22) a wiping angle of over 90 degrees.

6. The windshield wiper device according to claim 4, characterized in that upon deactivation of the wiper (102) the second wiping angle setting (22) is performed.

7. A method for operating a windshield wiper device (1), wherein a wiper (101, 102) wipes a predetermined wiping area, characterized in that the wiping field is adjusted depending on one or more parameters (13, 14).

8. The method according to claim 7, characterized in that the one or more parameters includes a wiper parameter (13).

9. The method according to claim 7, characterized in that the wiping angle of a first wiping angle setting (21) is smaller than the wiping angle of a second wiping angle setting (22).

10. The method according to claim 9, characterized in that a first wiping angle setting (21) comprises a wiping angle of 90 degrees and a second wiping angle setting (22) a wiping angle of over 90 degrees.

11. The method according to claim 9, characterized in that upon deactivation of the wiper (102) the second wiping angle setting (22) is performed.

12. The windshield wiper device according to claim 2, characterized in that the wiper parameter (13) comprises a wiper speed and/or an operating mode.

13. The windshield wiper device according to claim 1, characterized in that the one or more parameters includes an environmental parameter (14).

14. The windshield wiper device according to claim 13, characterized in that the environmental parameter (14) comprises a volume of water and/or a driving speed.

15. The windshield wiper device according to claim 4, characterized in that the wiping angle of the first wiping angle setting (21) is smaller than the wiping angle of the second wiping angle setting (22) by at least 3 degrees.

16. The method according to claim 8, characterized in that the wiper parameter (13) comprises a wiper speed and/or an operating mode.

17. The method according to claim 7, characterized in that the one or more parameters includes an environmental parameter (14).

18. The method according to claim 17, characterized in that the environmental parameter (14) comprises a volume of water and/or a driving speed.

19. The method according to claim 9, characterized in that the wiping angle of the first wiping angle setting (21) is smaller than the wiping angle of the second wiping angle setting (22) by at least 3 degrees.
